(19) United States
(12) Patent Application Publication
(10) Pub. No.: US 2014/0069810 A1
(43) Pub. Date: Mar. 13, 2014

(54) Electrochemical Corrosion Potential Sensor

(71) Applicant: HITACHI-GE NUCLEAR ENERGY, LTD., Hitachi-shi (JP)

(72) Inventors: Masahiko TACHIBANA, Hitachi-shi (JP); Kazushige ISHIDA, Hitachi-shi (JP); Yoichi WADA, Hitachinaka-shi (JP); Nobuyuki OTA, Hitachi-shi (JP); Ryosuke SHIMIZU, Mito-shi (JP)

(73) Assignee: Hitachi-GE Nuclear Energy, Ltd., Hitachi-shi (JP)

(21) Appl. No.: 13/860,293

(22) Filed: Apr. 10, 2013

(30) Foreign Application Priority Data
Sep. 7, 2012 (JP) 2012-196850

(51) Int. Cl. G01N 17/02

(52) U.S. Cl. CPC G01N 17/02
USPC 204/404

(57) ABSTRACT

An electrochemical corrosion potential sensor has a sensor unit, a lead wire and a quasi-reference electrode. A sensor unit includes a tube-shaped insulator, a tube-shaped metal casing joined to an end portion of the insulator, and a Pt electrode joined to another end portion of the insulator. A lead wire connected to the Pt electrode passes through the insulator and the metal casing. The quasi-reference electrode disposed in the metal casing is made of a less noble metal and electrically connected with the lead wire.

Since an electrochemical corrosion potential sensor has the quasi-reference electrode, the measurement of the corrosion potential of a structural member of a nuclear power plant and an abnormality occurrence (water intrusion) can be accurately detected during the operation of a nuclear power plant.

### CLAIM OF PRIORITY

The present application claims priority from Japanese Patent application serial no. 2012-196850, filed on Sep. 7, 2012, the content of which is hereby incorporated by reference into this application.

### BACKGROUND OF THE INVENTION

1. Technical Field

The present invention relates to an electrochemical corrosion potential sensor for measuring electrochemical corrosion potential of metallic structural member and, in particular, to an electrochemical corrosion potential sensor suitable for a nuclear power plant.

2. Background Art

Stainless steel and Ni-based alloys in a nuclear power plant are called structural materials and are used for structural members of reactor equipment, pipes and others. These structural materials are susceptible to stress corrosion cracking (hereinafter referred to as SCC) under specific conditions. Thus, preventive measures against SCC are being taken in order to maintain soundness of a nuclear power plant. Additionally, in recent years, preventive measures against SCC are applied to improve the economic performance of the nuclear power plant, such as improving its operating life and capacity factor. The preventive measures against SCC include techniques for improving the corrosion resistance of materials, improving stress, and mitigating a corrosive environment.

As one of the preventive measures against SCC in a boiling water nuclear power plant, hydrogen injection has been widely used, which is a method to improve a corrosive environment formed by nuclear reactor coolant (hereinafter, referred to as reactor water) contacting structural members of the boiling water nuclear power plant. An example of hydrogen water chemistry is described in Japanese Patent No. 2687780. The reactor water in the nuclear reactor contains oxygen and hydrogen peroxide generated by radiolysis of the reactor water and causing corrosion of the structural members. These oxygen and hydrogen peroxide form a corrosive environment. The hydrogen injection is a technique of injecting hydrogen in the reactor water through a feed water pipe so that the injected hydrogen can react with the oxygen and hydrogen peroxide contained in the reactor water to form water. The reaction decreases the concentrations of oxygen and hydrogen peroxide in the reactor water, consequently, the electrochemical corrosion potential (ECP) of the structural member contacting the reactor water is reduced, which mitigates the risk of SCC of the structural member.

As a technique for further promoting the reduction of electrochemical corrosion potential during the hydrogen injection, Japanese Patent Laid-open No. 4 (1992)-223299, for example, describes a technique to inject a platinum group noble metal element into the reactor water (Noblechem™). The noble metal injection used with hydrogen injection utilizes catalysis of the platinum group noble metal element in an oxidation reaction of hydrogen and further reduces the electrochemical corrosion potential reduced by the hydrogen injection.

The electrochemical corrosion potential of a structural member needs to be measured in order to implement these preventive measures against SCC for reducing the corrosive environment of the reactor water. Thus, an electrochemical corrosion potential sensor is installed in a reactor or in a pipe connected with the reactor to measure the electrochemical corrosion potential of the structural member. The electrochemical corrosion potential sensor generates a certain constant potential (reference potential) under the conditions of use, which potential is a reference for electrochemical corrosion potential measurement. For this reason, the electrochemical corrosion potential sensor is called a reference electrode. The electrochemical corrosion potential of a structural member can be obtained by using a potentiometer to measure the difference between the reference potential indicated by the electrochemical corrosion potential sensor and the potential shown under the conditions at the temperature of reactor water contacting the structural member of the boiling water nuclear power plant, the concentrations of oxygen and hydrogen peroxide contained in the reactor water, and the velocity of flow of reactor water.

Different examples of conventional electrochemical corrosion potential sensors are shown in Japanese Patent Laid-open No. 2000-65785, Japanese Patent Laid-open No. 2009-42111 and Proceedings of International Symposium on Plant Aging and Life Prediction of Corrodible Structures, May 15-18, 1995, Sapporo Japan, p. 413 JSCE-NACE (1995).

In addition, Japanese Patent Laid-open No. 2012-37364 discloses disposing a soundness diagnostic electrode in a casing of an electrochemical corrosion potential sensor and connecting the soundness diagnostic electrode through a potentiostat and an impedance analyzer to a grounded pipe which is a measuring object. The metal casing of the electrochemical corrosion potential sensor and the grounded target pipe are joined by welding and they are electrically connected to each other. The impedance analyzer is used to measure an impedance between the soundness diagnostic electrode and the grounded pipe which is a measuring object so that an impedance between the soundness diagnostic electrode and the metal casing of the electrochemical corrosion potential sensor can be measured. In this way, moisture intrusion into the metal casing of the electrochemical corrosion potential sensor can be detected and the soundness of the electrochemical corrosion potential sensor can be diagnosed while continuously measuring the electrochemical corrosion potential.

Japanese Patent Laid-open No. 4 (1992)-21305 discloses an electrochemical sensor for detecting moisture intrusion, which uses different metals that generate a potential difference when they are brought in contact with an electrolyte (moisture) and uses a pH analyzer (voltage measuring apparatus) for detecting the generated potential difference. The electrochemical sensor has a half-cell (sensor sensing electrode), a reference cell, a zinc wire, and a silver wire. The zinc wire is connected to a conductor connected to the half-cell. The silver wire and the reference cell (sensor reference electrode) disposed near the zinc wire, are connected to a coaxial cable connected to the conductor. The zinc wire and the silver wire generate potential difference. When the sensor is damaged and moisture intrudes into the sensor, a potential difference generated between the zinc and the silver wires is measured by the voltage measuring apparatus, so that the damage to the electrochemical sensor due to the moisture intrusion is detected.

### CITATION LIST

### Patent Literature

[Patent Literature 1] Japanese Patent No. 2687780
[Patent Literature 2] Japanese Patent Laid-open No. 4 (1992)-223299
[Patent Literature 3] Japanese Patent Laid-open No. 2000-65785
[Patent Literature 4] Japanese Patent Laid-open No. 2009-42111
[Patent Literature 5] Japanese Patent Laid-open No. 2012-37364
[Patent Literature 6] Japanese Patent Laid-open No. 4 (1992)-213052

### Non Patent Literature

[Non Patent literature 1] Proceedings of International Symposium on Plant Aging and Life Prediction of Corrodible Structures, May 15-18, 1995, Sapporo Japan, p. 413 JSCE-NACE (1995)

### SUMMARY OF THE INVENTION

### Technical Problem

The inventors have studied the malfunction in an electrochemical corrosion potential sensor. The details of this study will be explained. FIG. 6 is a result of hydrogen injection into the reactor water in a nuclear reactor in a boiling water nuclear power plant, showing changes in the concentration of dissolved oxygen in the reactor water sampled by a sampling system to the concentration of hydrogen in feed water supplied to the reactor, and changes in the electrochemical corrosion potential of a structural material of the plant to the concentration of hydrogen in the feed water. It shows that when the hydrogen concentration in the feed water is increased, the dissolved oxygen concentration in the reactor water is decreased, and following that, the electrochemical corrosion potential of the structural member is reduced. Thus, an electrochemical corrosion potential sensor is necessary to accurately measure the electrochemical corrosion potential, and the electrochemical corrosion potential sensor needs to be usable under the operating conditions of the nuclear power plant.

In order to measure the electrochemical corrosion potential of a structural member of a nuclear power plant, the soundness of an electrochemical corrosion potential sensor in the in-service period needs to be checked. For example, when the electrochemical corrosion potential sensor is used for continuous measurement during one operation cycle (13 months, 18 months, or 24 months) after its installation, the soundness period of the electrochemical corrosion potential sensor may need to be known to evaluate the validity of electrochemical corrosion potential data obtained. In a nuclear power plant, however, when the electrochemical corrosion potential sensor is installed in the reactor or a pipe near the reactor, the electrochemical corrosion potential sensor's casing is fixed to the pipe by welding. When the nuclear power plant is in operation, such place of installation of the electrochemical corrosion potential sensor cannot be approached. Thus, once the electrochemical corrosion potential sensor is installed, it cannot be removed during the period of electrochemical corrosion potential measurement for the sake of verifying its soundness.

Therefore, in order to verify the soundness of the electrochemical corrosion potential sensor, the water condition of the reactor water can be changed to see whether the potential difference between the electrode and the pipe changes according to the change in water condition. The potential of the electrode shows a certain standard potential if the electrochemical corrosion potential sensor is soundness, so when the potential difference (corresponding to the corrosion potential of the pipe) between the pipe and the electrode changes according to the change in water condition, it can be determined that the electrochemical corrosion potential sensor is soundness. However, it is not preferable to change the water condition of the reactor water often during the operation of the nuclear power plant for the sake of verifying the soundness of the electrochemical corrosion potential sensor.

The easiest way to determine the normality of the electrochemical corrosion potential sensor during the operation period of the nuclear power plant is to confirm that the electrochemical corrosion potential sensor maintains a certain potential with respect to the structural material which is the measuring object, that is, to confirm that the potential of the electrochemical corrosion potential sensor generated with respect to the ground level is not 0V.

FIG. 7 is an explanatory drawing showing usage pattern of an electrochemical corrosion potential sensor in a nuclear power plant. FIG. 7 shows in a state in which the electrochemical corrosion potential sensor is used to measure the electrochemical corrosion potential of a metal pipe which is a structural member made of a metal for introducing the reactor water. A cylindrical metal casing 4 of an electrochemical corrosion potential sensor 1 is joined by welding to a T-shaped pipe 6. A potential detection section 3 electrically insulated from the metal casing 4 of the electrochemical corrosion potential sensor 1 by a cylindrical insulator 2 is come into contact with the reactor water. The interior of the electrochemical corrosion potential sensor 1 is tightly sealed against the reactor water. A lead wire 9 is fixed by welding to an inner surface of the detection section 3 facing the interior of the electrochemical corrosion potential sensor 1. The lead wire 9 passes through an interiors of the cylindrical insulator 2 and the cylindrical metal casing 4, and a mineral insulated cable 8, and reaches an outside of the cylindrical metal casing 4, so that the lead wire 9 is connected to a core wire 10 in the outside of the cylindrical metal casing 4. The core wire 10 is connected through conducting wires 12a and 12b and a potentiometer 13 to a metal pipe 14 which is a main pipe for introducing the reactor water.

In the measurement of electrochemical corrosion potential using the structure shown in FIG. 7, when water intrudes into the electrochemical corrosion potential sensor 1 and as a result, the sensor is damaged, the reading of the potentiometer 13 becomes 0V. The electrochemical corrosion potential is evaluated by measuring a potential difference between the electrochemical corrosion potential sensor 1 and the T-shaped pipe 6 or the metal pipe 14. The T-shaped pipe 6 is connected to the metal pipe 14, which is a structural member of the nuclear power plant, connected to reactor pressure vessel (not shown) and introducing the reactor water. Since the electrochemical corrosion potential sensor 1 is fixed to the metal pipe 14 by welding, the metal casing 4 of the electrochemical corrosion potential sensor 1 is electrically connected to the metal pipe 14. Since the metal pipe 14 is grounded, the metal casing 4 of the electrochemical corrosion potential sensor 1 is consequently grounded.

When the electrochemical corrosion potential sensor 1 is soundness, the potential difference between the potential detector 3 and the T-shaped pipe 6 along a path A is measured by the potentiometer 13. However, when an accident happens to the brazing portion between the insulator 2 and the metal casing 4 of the electrochemical corrosion potential sensor 1 and the reactor water intrudes into the metal casing 4, the lead wire 9 in the electrochemical corrosion potential sensor 1 and the metal casing 4 of the electrochemical corrosion potential sensor 1 become conductive, and the potential difference is measured along a path B. Because of this, the potential of the potential detection section 3 of the electrochemical corrosion potential sensor 1 is not outputted. In this case, the reading of the potentiometer 13 does not show the potential difference along the path A, and the electrochemical corrosion potential is calculated from the potential difference generated along the path B.

Normally, the lead wire 9 and the metal casing 4 of the electrochemical corrosion potential sensor 1 are produced from a noble metal or a passive metal. Consequently, when the lead wire 9 and the metal casing 4 are come into contact with the reactor water due to damage to the electrochemical corrosion potential sensor 1, they generate the same potentials and the reading of the potentiometer 13 shows 0V. Thus, the soundness of the electrochemical corrosion potential sensor 1 can be determined by confirming a state where the reading of the potentiometer 13 is continuously not 0V.

However, when the noble metal injection technique mentioned in Japanese Patent Laid-open No. 4 (1992)-223299 is applied and Pt is deposited to the surface of the structural member of the nuclear power plant, the above method cannot be used to determine the soundness of the sensor. When the noble metal injection technique is applied, the metal material of the metal pipe which is a measuring object also generates the same potential as Pt. Because of this, when the electrochemical corrosion potential of the metal material to which the noble metal injection technique is applied is measured by using the Pt-type electrochemical corrosion potential sensor, the reading of the potentiometer will be 0V even when the Pt-type electrochemical corrosion potential sensor is soundness. Thus, even when water intrudes into the electrochemical corrosion potential sensor as a result of damage, the electric output does not necessarily change, so that it is difficult to detect the damage to the electrochemical corrosion potential sensor.

Therefore, as one method, voltage may be applied to measure resistance between the metal material and a signal line for measuring the corrosion potential of the electrochemical corrosion potential sensor, so that whether appropriate electrical insulation is maintained or not is determined to confirm the normality of the functions of the electrochemical corrosion potential sensor. However, in order to measure the resistance, DC voltage of volt unit need to be applied to the electrochemical corrosion potential sensor, which hinders the potentiometer to indicate the corrosion potential, thus it would be difficult to check the soundness of the sensor during the corrosion potential measurement. Furthermore, since the application of DC voltage of volt unit polarizes the electrodes mounted in the potential generating portion of the electrochemical corrosion potential sensor, it may cause adverse effect on the reading of the potential of the electrochemical corrosion potential sensor after the application.

As another method, a secondary electrode for diagnosis which detects water intrusion is loaded in the metal casing of the electrochemical corrosion potential sensor and a weak AC voltage is applied between the secondary electrode and the metal material so that the impedance response can be measured to verify if appropriate electric insulation is maintained. In this way, the soundness of the electrochemical corrosion potential sensor can be verified. In the electrochemical corrosion potential sensor described in Japanese Patent Laid-open No. 2012-37364, the soundness diagnostic electrode is disposed in the metal casing of the electrochemical corrosion potential sensor, millivolt of weak AC voltage is applied between the health diagnostic electrode and the lead wire for measuring the corrosion potential by using the impedance analyzer connected to the potentiostat, and damage to the electrochemical corrosion potential sensor is detected by monitoring a change in the impedance response caused by moisture intrusion. In this method, the soundness of the electrochemical corrosion potential sensor can be evaluated continuously during the corrosion potential measurement without affecting the reading of the electrochemical corrosion potential sensor. However, when the electrochemical sensor described in Japanese Patent Laid-open No. 2012-37364 is used as the electrochemical corrosion potential sensor, the lead wire for sending a signal from the soundness diagnostic electrode to the outside of the electrochemical corrosion potential sensor needs to be provided separately from the lead wire for measuring the corrosion potential, so that the structure of the electrochemical corrosion potential sensor increases in complexity. Moreover, the diagnostic potentiostat and the diagnostic impedance analyzer are needed in addition to the potentiometer for measuring the corrosion potential, so that both the measuring and the measured systems increase in complexity and the cost increases.

The electrochemical sensor described in Japanese Patent Laid-open No. 4 (1992)-213052 has a half-cell (a sensor sensing electrode), a reference electrode, zinc and silver wires, and an electrolyte supplier; and at the occurrence of water intrusion, the electrolyte is resolved in the metal casing of the electrochemical sensor and damage to the electrochemical sensor caused by the moisture intrusion is detected by measuring a potential difference generated between the zinc wire and the silver wire disposed near the zinc wire. In Japanese Patent Laid-open No. 4 (1992)-213052, since the pH analyzer (voltage measuring apparatus) used for measuring the corrosion potential can be used to check the soundness of the sensor, damage to the electrochemical sensor can be detected without complicating the measuring system. However, when this electrochemical sensor is used as the electrochemical corrosion potential sensor, two electrodes (zinc and silver electrodes) for detecting moisture intrusion and the electrolyte supplier need to be mounted inside the metal casing of the electrochemical corrosion potential sensor, so that the structure of the measured system increases unfortunately in complexity. In addition, since the electrochemical sensor in Japanese Patent Laid-open No. 4 (1992)-213052 has the electrolyte supplier, when the electrochemical sensor cracks and the reactor water intrudes inside, the electrolyte may be discharged from the electrochemical sensor to the reactor water outside and may affect the water quality of the reactor water.

For these reasons, a method which requires a simple structure both in the measuring and the measured systems and which allows the soundness to be verified during the in-service period of the electrochemical corrosion potential sensor without affecting reactor water at the occurrence of damage has been desired.

An object of the present invention is to provide an electrochemical corrosion potential sensor which has a simple structure both in measuring and measured systems and allows corrosion potential of a structural member a plant to be measured and also an abnormality occurrence to be accurately detected during operation of the plant.

### Solution to Problem

In consideration of the above issues, the inventors have made studies of an electrochemical corrosion potential sensor which allows corrosion potential of a structural member of a plant (for example, a nuclear power plant) to be accurately measured and also the soundness of the electrochemical corrosion potential sensor to be verified during the operation of the plant. As a result, the inventors have found out that an abnormality occurrence in the electrochemical corrosion potential sensor by water intrusion can be detected by disposing, in the electrochemical corrosion potential sensor, an electrode which generates an electrode potential only when the water intrudes into the electrochemical corrosion potential sensor due to damage to the sensor, which the electrode potential is different from those of a lead wire and a metal casing of the electrochemical corrosion potential sensor.

In order to achieve the above object, an electrochemical corrosion potential sensor of the present invention includes a sensor unit having a metal casing and a corrosion potential detecting electrode attached to the metal casing and electrically insulated from the metal casing; a lead wire connected to the corrosion potential detecting electrode, passed through in the sensor unit and extended to an outside of the sensor unit; and a quasi-reference electrode disposed in the metal casing of the sensor unit and made of a less noble metal electrically connected with either the corrosion potential detecting electrode or the metal casing.

It is preferable that the less noble metal includes at least one of zirconium, zinc, aluminum, tin, manganese, tantalum, and iron.

The above object can be achieved by observing, for example, a precipitous potential change at the occurrence of water intrusion caused by damage to the electrochemical corrosion potential sensor, and detecting that the output of the potentiometer is not 0V. Thus, it can also be achieved by producing the lead wire of the electrochemical corrosion potential sensor with a less noble metal or by laying the less noble metal on the inner surface of the metal casing instead of using the lead wire of the electrochemical corrosion potential sensor to measure the potential difference.

### Advantageous Effect of the Invention

According to the present invention, the electrochemical corrosion potential sensor for measuring the corrosion potential of a metallic structural member of a plant which comes into contact with water (for example, coolant used in the nuclear power plant) has an electrochemical corrosion detecting electrode contacting the water, the interior side of the electrochemical corrosion potential detecting electrode is tightly sealed against the water; a lead wire connected to the corrosion potential detecting electrode; and a quasi-reference electrode made of a less noble metal which, when contacting a metal member in the corrosion potential sensor, generates potential less noble than the corrosion potential detecting electrode, the lead wire and at the temperature and pH at which the corrosion potential sensor is used, and the output of the quasi-reference electrode is used to monitor the soundness of the electrochemical corrosion potential sensor; this allows continuous monitoring of occurrence of malfunction involving water intrusion into the electrochemical corrosion potential sensor and allows accurate measuring of the corrosion potential of the structural member of the plant during the operation of the plant.

### BRIEF DESCRIPTION OF THE DRAWINGS

FIG. 1A is a longitudinal sectional view showing a conventional electrochemical corrosion potential sensor.

FIG. 1B is a longitudinal sectional view showing an electrochemical corrosion potential sensor according to embodiment 1 which is a preferred embodiment of the present invention.

FIG. 2 is a characteristic drawing showing changes in the reading of a potentiometer over time in an electrochemical corrosion potential sensor shown in FIG. 1B and a conventional electrochemical corrosion potential sensor shown in FIG. 1A during the periods before and after damage to the electrochemical corrosion potential sensors.

FIG. 3 is a longitudinal sectional view showing an electrochemical corrosion potential measuring apparatus having an electrochemical corrosion potential sensor shown in FIG. 1B.

FIG. 4 is a longitudinal sectional view showing an electrochemical corrosion potential measuring apparatus having an electrochemical corrosion potential sensor according to embodiment 2 which is another preferred embodiment of the present invention.

FIG. 5 is a longitudinal sectional view showing an electrochemical corrosion potential measuring apparatus having an electrochemical corrosion potential sensor according to embodiment 3 which is another preferred embodiment of the present invention.

FIG. 6 is a characteristic drawing showing concentration of oxygen dissolved in reactor water and corrosion potential of a structural member of a nuclear power plant as a function of concentration of hydrogen in feed water during hydrogen injection.

FIG. 7 is a longitudinal sectional view showing an electrochemical corrosion potential measuring apparatus having a conventional electrochemical corrosion potential sensor shown in FIG. 1A.

### DETAILED DESCRIPTION OF THE PREFERRED EMBODIMENTS

Embodiments of the present invention will be described below by referring drawings.

### Embodiment 1

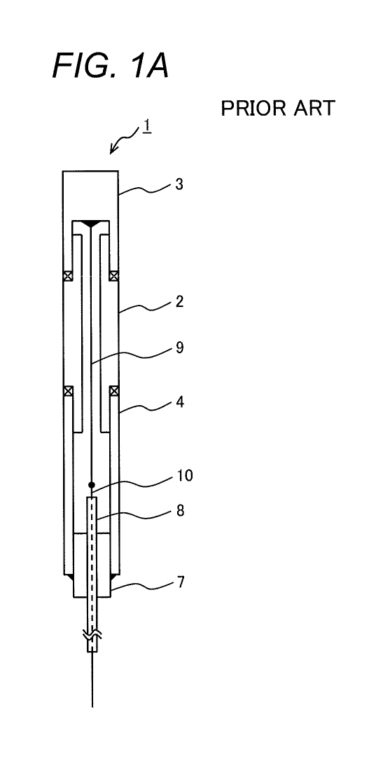

FIG. 1A shows a conventional electrochemical corrosion potential sensor including Pt (a conventional Pt-type electrochemical corrosion potential sensor). FIG. 1B shows an electrochemical corrosion potential sensor including Pt (a Pt-type electrochemical corrosion potential sensor) of the present invention.

The conventional Pt-type electrochemical corrosion potential sensor has a Pt electrode 3, a cylindrical insulator 2 and a metal casing 4. The Pt electrode 3 is attached to an end of the cylindrical insulator 2, the other end of the cylindrical insulator 2 is fixed to an end portion of the metal casing 4, and an end plug 7 is joined to the other end portion of the metal casing 4. A mineral insulated cable 8 penetrates the end plug 7 and is mounted to the end plug 7. The lead wire 9 made of Pt connected to the Pt electrode 3 passes through the interior of the insulator 2 and is connected to a core wire 10 of the mineral insulated cable 8.

An electrochemical corrosion potential sensor according to embodiment 1 which is a preferred embodiment of the present invention will be described by referring to FIG. 1B. The electrochemical corrosion potential sensor 101 of the present embodiment is a Pt-type electrochemical corrosion potential sensor and has a structure that a Zn electrode 11 is added to the conventional electrochemical corrosion potential sensor 1. The Zn electrode 11, which is a quasi-reference electrode made of a less noble metal, is installed around the lead wire 9 made of Pt. The electrochemical corrosion potential sensor 101 has a sensor unit 15 including a Pt electrode 3, a cylindrical insulator 2 and a metal casing 4. The other structure of the electrochemical corrosion potential sensor 101 is the same as that of the conventional electrochemical corrosion potential sensor 1.

The characteristics of the electrochemical corrosion potential sensor 101 according to the present embodiment is that it has a simple structure where only one electrode (for example, the Zn electrode 11) made of a less noble metal is added to the measured system in the existing electrochemical corrosion potential sensor 1, and that the potentiometer normally used for measuring corrosion potential can be used as is for verifying the soundness of the sensor. This simple structure both in the measuring and measured systems can solve the previously described problems.

In the electrochemical corrosion potential sensor 101, the measurement of the corrosion potential is taken along a path having the least impedance (resistance), so in case of water intrusion, a potential measurement circuit is formed through the path having the least resistance, that is, a path between the Zn electrode 11 and the metal casing 4. Using a less noble metal which is very corrosive at the temperature and pH of the usage environment increases the corrosion current density so that the potential of the less noble metal electrode (for example, the Zn electrode 11) is indicated. Thus, when the electrochemical corrosion potential sensor 101 is damaged and water intrudes inside, a potential measurement circuit is formed between the less noble metal electrode (for example, the Zn electrode 11) and the metal casing 4 of the electrochemical corrosion potential sensor 101, and the potential of the less noble metal electrode is transmitted to the measuring system only when there is water intrusion due to the damage.

The range of corrosion potential, a noble metal or a passive metal could have in reactor water environment is approximately +0.2 to −0.6Vvs.SHE. Thus, when the reading of the potential of a less noble metal electrode which generates a less noble potential of −0.8Vvs.SHE in the reactor water environment, for example, is outputted at the occurrence of sensor damage, a precipitous change in the reading of the potentiometer of at least −0.2V in the less noble potential direction will be observed. For this reason, a change in the reading of the potentiometer over time can be continuously monitored, so that the soundness of the electrochemical corrosion potential sensor 101 can be determined.

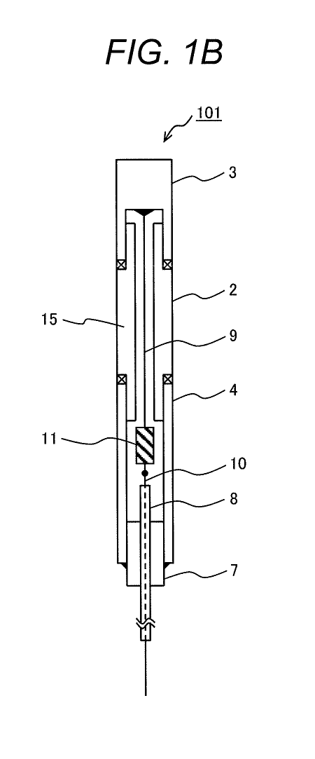

For this reason, as shown in an example in FIG. 2, when the noble metal injection technique is applied to the corrosion potential measurement using the Pt-type electrochemical corrosion potential sensor, the reading of the potential of the potentiometer is unchanged before and after the damage when the conventional Pt-type electrochemical corrosion potential sensor is used. However, when the Pt-type electrochemical corrosion potential sensor 101 according to the present embodiment is used, a precipitous change in the potential of the less noble metal electrode, that is, the Zn electrode 11 in the less noble direction can be detected by the potentiometer at the occurrence of water intrusion due to the damage to the electrochemical corrosion potential sensor 101. As a consequence, the time when functions of the electrochemical corrosion potential sensor 101 are lost is detected.

The electrochemical corrosion potential sensor 101 having the Zn electrode 11 allows the soundness to be verified while the corrosion potential is continuously being measured. Furthermore, it is preferred to measure, in advance, the potential of the less noble metal electrode in water at the temperature at which the electrochemical corrosion potential sensor 101 is used.

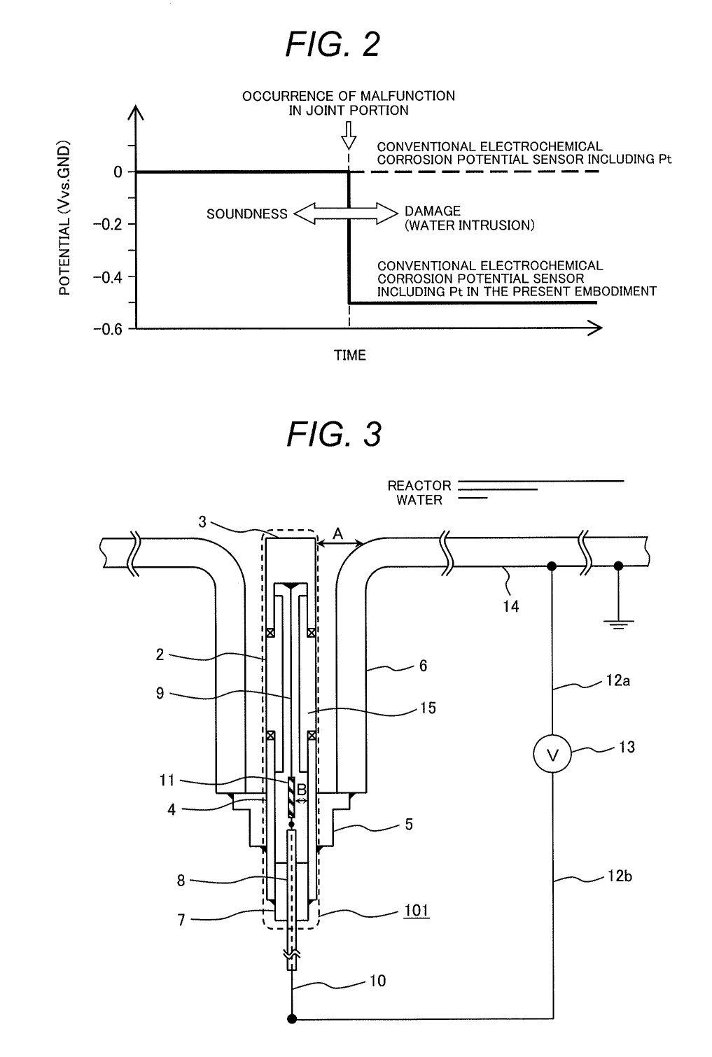

An electrochemical corrosion potential measuring apparatus having an electrochemical corrosion potential sensor 101 and a potentiometer 13 as shown in FIG. 1B will be described with reference to FIG. 3. FIG. 3 shows a usage state of the Pt-type electrochemical corrosion potential sensor 101.

In the electrochemical corrosion potential sensor 101, the Pt electrode (a corrosion potential detecting electrode) 3 is attached at one end of the cylindrical insulator 2, the other end of the insulator 2 is fixed to the end portion of the metal casing 4, the end plug 7 is joined to the other end portion of the metal casing 4 by welding. The mineral insulated cable (MI cable) 8 penetrates the end plug 7 and a sheath of the mineral insulated cable 8 fixed to the end plug 7. The lead wire 9 made of Pt connected to the Pt electrode 3 runs through the interior of the insulator 2 and is connected to the core wire 10 of the mineral insulated cable 8. The metal casing 4 is installed by welding through an adapter 5 to a T-shaped pipe 6 connected to a metal pipe 14 which is connected to a reactor pressure vessel (not shown). The metal pipe 14 is a structural member of the nuclear power plant, that is, a part of a piping system connected to the reactor pressure vessel of the nuclear power plant. The interior of the electrochemical corrosion potential sensor 1 is tightly sealed against the reactor water flowing in the metal pipe 14 and T-shaped pipe 6.

The Zn electrode 11 is installed around the lead wire 9 and functions as a so-called quasi-reference electrode for outputting a certain relative potential at the time of measurement.

The core wire 10 of the mineral insulated cable 8 drawn out from the Pt-type electrochemical corrosion potential sensor 101 is connected to the T-shaped pipe 6 through a lead wire 12b, the potentiometer 13, and a lead wire 12a and the corrosion potential of the T-shaped pipe 6, that is, the metal pipe 14 is measured using the potentiometer 13. An example of this corrosion potential measurement is shown below.

In the Pt-type electrochemical corrosion potential sensor 101 according to the present embodiment, the Pt electrode 3 which is a main portion for generating and detecting potential is joined by brazing to an end portion of the cylindrical insulator 2 made of highly-pure sapphire, the other end of the insulator 2 is joined by brazing to the cylindrical metal casing 4 made of 42 alloy which is a Ni—Fe alloy having a low thermal expansion rate, the other end of the metal casing 4 is joined by welding to the cylindrical end plug 7 made of stainless steel. Furthermore, the Zn electrode 11 is joined by hot dip galvanization around a part or the entire periphery of the lead wire 9 made of Pt as a quasi-reference electrode, one end of the lead wire 9 is connected to the Pt electrode 3 by welding. The other end of the lead wire 9 is joined by welding to the core wire 10 insulated from the sheath of the mineral insulated cable, and the core wire 10 is drawn outside the electrochemical corrosion potential sensor 101. The metal casing 4 is joined by welding to the T-shaped pipe 6 made of stainless steel through the adapter 5 made of stainless steel, the sheath of the mineral insulated cable 8 is joined to the inside of the end plug 7.

While the core wire 10 drawn out from the Pt-type electrochemical corrosion potential sensor 101 is connected to the T-shaped pipe 6 through the lead wire 12b, the potentiometer 13, the lead wire 12a, and the metal pipe 14, the corrosion potential of the T-shaped pipe 6 coming into contact with the reactor water is measured.

In FIG. 3, “A” shows a potential measurement path when the sensor 101 is soundness and “B” shows a potential measurement path when water intrusion is caused by damage of the sensor 101. In the structure shown in FIG. 3, the metal casing 4 of the Pt-type electrochemical corrosion potential sensor 101 is electrically in conduction with the T-shaped pipe 6. That is, the metal casing 4 is grounded through the T-shaped pipe 6.

When the electrochemical corrosion potential sensor 101 is soundness, the Pt electrode 3 generates an electrode potential by the redox reaction of oxygen and hydrogen contained in the reactor water. In the same manner, the inner surface of the T-shaped pipe 6 also generates an electrode potential according to the concentrations of oxygen and hydrogen in the reactor water and a potential difference between the Pt electrode 3 and the T-shaped pipe 6 along the path A is measured. The electrochemical corrosion potential sensor 101 outputs the same potential as the conventional Pt-type electrochemical corrosion potential sensor because the Zn electrode 11 is not come into contact with the reactor water in a normal condition.

On the other hand, when the insulator 2 or the joint portion between the insulator 2 and the metal casing 4 made of 42 alloy joined by brazing is damaged and the reactor water existing in the T-shaped pipe 6 intrudes into the metal casing 4, the Zn electrode 11 comes in contact with the reactor water and generates an electrode potential. Moreover, since the Zn electrode 11 becomes electrically connected with the metal casing 4 through the reactor water, a short circuit is formed along the path B. At this time, the Zn electrode 11, which is a quasi-reference electrode, has a corrosion reaction by contacting the reactor water and a less noble potential (negative potential) is generated. This less noble potential is an equilibrium potential less noble than the equilibrium potential [Eeq=Eo+(RT/nF) 1n (aOx/aRed)] of at least one of an oxidation reaction of H2/H+ and a redox reaction of H₂/H₂O (H₂+2OH←→2H₂O+2e-) and less noble than the corrosion potential detecting electrode, the lead wire and the metal casing at the temperature and pH at which the corrosion potential sensor 101 is used. Thus, only when water intrudes into the metal casing 4 due to damage, an electrode potential difference between the metal casing 4 and the Zn electrode 11 is measured by the potentiometer 13. The above equation expressing the equilibrium potential Eeq is Nernst equation. In this equation, Eo is standard potential, R is a gas constant, T is temperature of liquid that comes into contact with an electrochemical corrosion potential sensor, n is charge number, F is Faraday constant, aOx is an oxidant activity, and aRed is reductant activity.

That is, as schematically shown in FIG. 2, a precipitous negative change in the reading of the potentiometer 13 occurs between the periods before and after the water intrusion due to damage. This is because, while a noble metal as represented by Pt and a passive metal having slow corrosion rate indicate the redox potential of water/oxygen or water/hydrogen according to the concentrations of oxygen and hydrogen contained in the reactor water, a less noble metal having a faster corrosion speed in the reactor water compared to stainless steel and 42 alloy indicates the corrosion potential of the corrosion reaction of the less noble metal.

Thus, in the electrochemical corrosion potential sensor having the structure that is, the Zn electrode 11 is installed in contact with the lead wire 9, the Zn electrode 11 is come into contact with the reactor water only at the occurrence of water intrusion, and the electrode potential generated at the Zn electrode 11 is transmitted to the core wire 10, to indicate a potential other than the redox potential of water/oxygen or water/hydrogen can be indicated, and a precipitous change in the potential and a difference in absolute values can be continuously monitored, so that the water intrusion due to damage of the electrochemical corrosion potential sensor 101 can be certainly detected. Furthermore, the electrochemical corrosion potential sensor 101 can measure accurately the corrosion potential of the structural member during the operation of the nuclear power plant.

### Embodiment 2

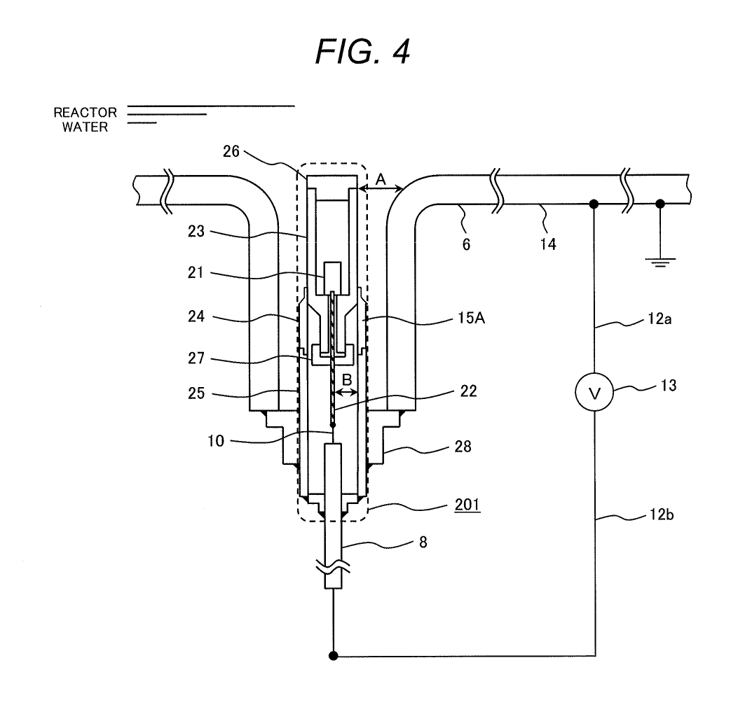

An electrochemical corrosion potential measuring apparatus having an electrochemical corrosion potential sensor according to embodiment 2 which is another preferred embodiment of the present invention will be described with reference to FIG. 4. In the present embodiment, a silver-silver chloride-type electrochemical corrosion potential sensor 201 including a silver-silver chloride electrode 21 is used as an electrochemical corrosion potential sensor for generating a reference potential. the electrochemical corrosion potential sensor 201 has a lead wire 22 made of Zr as a quasi-reference electrode functioning as a lead wire for transmitting the electrode potential generated at the silver-silver chloride electrode 21 and as a less noble metal electrode for generating a less noble potential at the occurrence of water intrusion. The electrochemical corrosion potential sensor 201 has a sensor unit 15A including a cover 26, a cylindrical insulator 23, an external sleeve 24 and a metal casing 25. In embodiment 2, the electrochemical corrosion potential measuring apparatus has an electrochemical corrosion potential sensor 201 and a potentiometer 13.

In the silver-silver chloride-type electrochemical corrosion potential sensor 201, an insulator 23 made of highly-pure sapphire is joined by brazing through the external sleeve 24 to the metal casing 25, the metal casing 25 is connected through an adapter 28 to the T-shaped pipe 6 for measuring a corrosion potential. The silver-silver chloride electrode 21 is disposed in a water chamber in the insulator 23, and the cover 26 made of highly-pure sapphire is fixed to an end portion of the insulator 23.

Furthermore, the silver-silver chloride electrode 21 is connected to the lead wire 22 made of Zr, the lead wire 22 drawn outside through an interior sleeve 27 fixed to another end portion of the insulator 23 is connected by welding to the core wire 10 in the metal casing 25. The core wire 10 is drawn outside the metal casing 25 and connected to the T-shaped pipe 6 through the lead wire 12b, the potentiometer 13, the lead wire 12a, and the metal pipe 14.

Based on the above structure, the potential generated at the silver-silver chloride electrode 21 along the path A is measured by the potentiometer 13 during the period when the electrochemical corrosion potential sensor is soundness. At this time, since the lead wire 22 made of Zr is not come into contact with the reactor water, the same potential as the conventional silver-silver chloride-type electrochemical corrosion potential sensor is outputted.

On the other hand, when the insulator 23 or the joint portion between the insulator 23 and the exterior sleeve 24 made of 42 alloy joined by brazing is damaged and the reactor water intrudes into the metal casing 25, the lead wire 22 made of Zr generates an electrode potential and a short circuit is formed between the lead wire 22 and the metal casing 25 along the path B. Since Zr is a less noble metal, a corrosion reaction proceeds and a negative potential is generated. Thus, only when there is water intrusion due to damage, the potential of the lead wire 22 made of Zr with respect to the metal casing 25 is measured. While Pt or a metal having a slow corrosion rate generates the redox potential of water and oxygen or water and hydrogen, Zr having a faster corrosion rate in the reactor water compared to stainless steel and 42 alloy is connected in the electrochemical corrosion potential sensor 201 so that water intrusion due to damage can be detected. The other structures of the electrochemical corrosion potential sensor 201 are the same as that of the electrochemical corrosion potential sensor 101 in embodiment 1, so further description is omitted.

### Embodiment 3

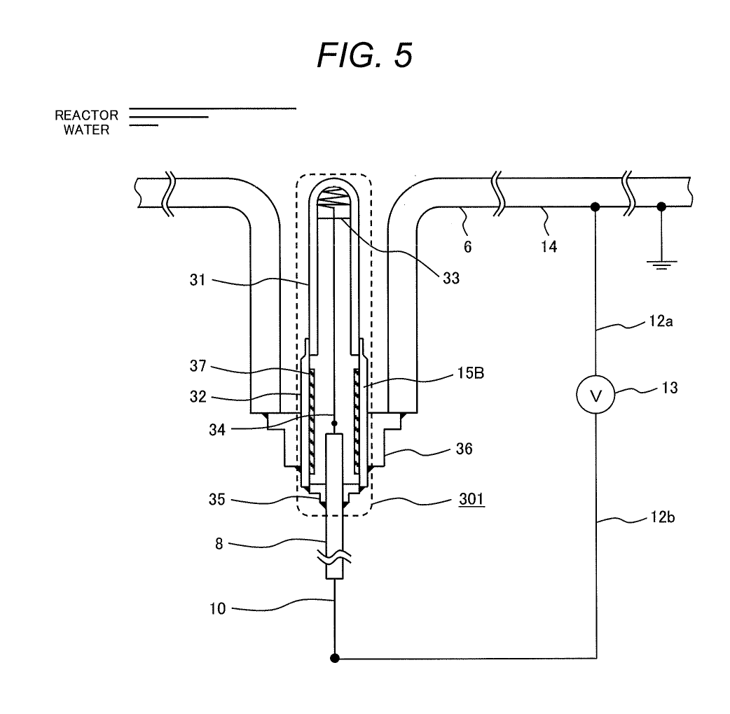

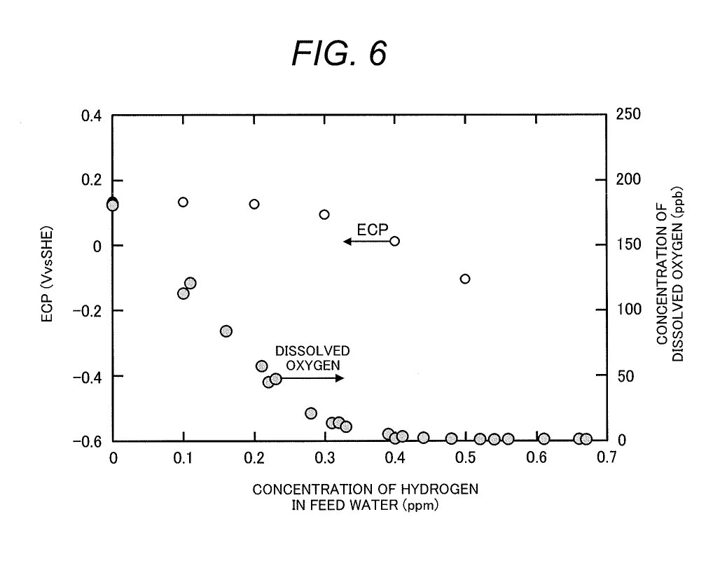

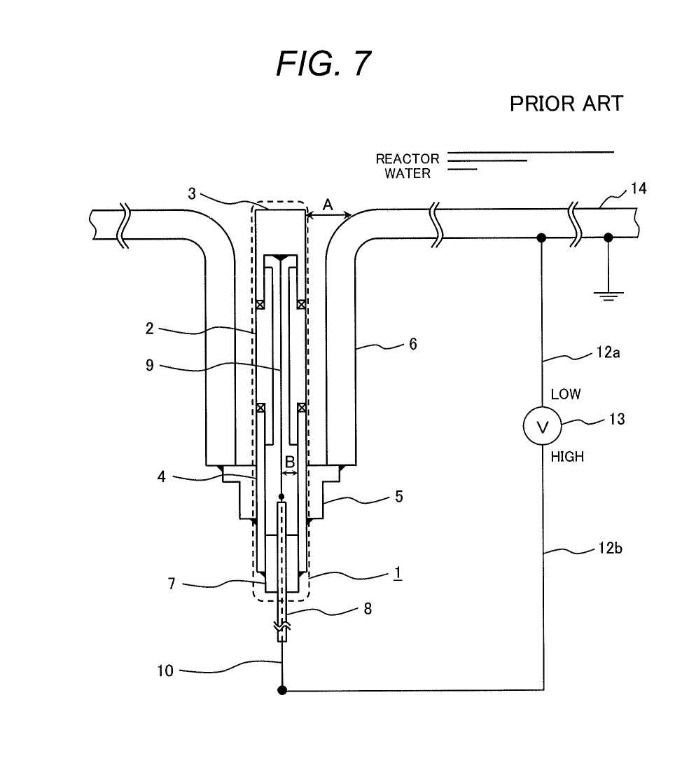

An electrochemical corrosion potential measuring apparatus having an electrochemical corrosion potential sensor according to embodiment 3 which is another preferred embodiment of the present invention will be described with reference to FIG. 5. In the present embodiment, a zirconia membrane-type electrochemical corrosion potential sensor 301 is used as an electrochemical corrosion potential sensor generating a reference potential. A potential detection section of the zirconia membrane-type electrochemical corrosion potential sensor 301 is a region where a catalyst is filled in a cylindrical zirconia membrane 31 made of zirconia (ZrO2) located at a top portion of the sensor. The electrochemical corrosion potential sensor 301 has a sensor unit 15B including the zirconia membrane 31 and a metal casing 32. In embodiment 3, the electrochemical corrosion potential measuring apparatus has an electrochemical corrosion potential sensor 301 and a potentiometer 13.

In the zirconia membrane-type electrochemical corrosion potential sensor 301 according to the present embodiment, the zirconia membrane 31, which is an insulator, is joined by brazing to an end portion of the metal casing 32, a membranous Sn electrode 37 is formed as a quasi-reference electrode on part of an inner surface of the metal casing 32. An end plug 35 is mounted to another end portion of the metal casing 32. Furthermore, platinum black powder 33 is filled in a sealed space inside the zirconia membrane 31, a lead wire 34 made of Pt is inserted into the platinum black powder 33, and the lead wire 34 is connected to the core wire 10 in the mineral insulated cable 8 penetrating the end plug 35. The metal casing 32 is connected by welding through an adapter 36 to the T-shaped pipe 6 The core wire 10 of the mineral insulated cable 8 is drawn outside through the end plug 35, and connected to the T-shaped pipe 6 through the lead wire 12b, the potentiometer 13, the lead wire 12a, and the metal pipe 14.

In the present embodiment, only when water intrudes into the zirconia membrane-type electrochemical corrosion potential sensor 301, an electrode potential difference between the Pt lead wire 34 and the Sn electrode 37 is measured. In embodiment 3, unlike embodiments 1 and 2, the reading of the potentiometer between the periods before and after the water intrusion is changed precipitously in the positive direction from a less noble potential (negative potential) to a more noble potential (positive potential). Thus, the reading of the potentiometer can be continuously monitored and a precipitous increase in the potential of the electrochemical corrosion potential sensor 301 with respect to the pipe 6 can be detected to detect water intrusion caused by damage. The other structure is the same as those in embodiments 1 and 2 so further description is omitted.

### REFERENCE SIGNS LIST

1, 101, 201, 301: electrochemical corrosion potential sensor, 2, 23: insulator, 3: Pt electrode, 4, 25, 32: metal casing, 6: T-shaped pipe, 9, 34: lead wire, 10: core wire, 11: Zn electrode, 13: potentiometer, 14: metal pipe, 15, 15A, 15B: sensor unit, 21: silver-silver chloride electrode, 31: zirconia membrane, 33: platinum black powder, 37: Sn electrode.

What is claimed is:

1. An electrochemical corrosion potential sensor comprising:
a sensor unit including a tube-shaped metal casing and a corrosion potential detecting electrode attached to the metal casing and electrically insulated from the metal casing;
a lead wire connected to the corrosion potential detecting electrode, passed through in the sensor unit and extended to an outside of the sensor unit; and
a quasi-reference electrode disposed in the metal casing of the sensor unit and made of a less noble metal electrically connected with either the corrosion potential detecting electrode or the metal casing, the less noble metal generating potential less noble than the corrosion potential detecting electrode, the lead wire and the metal casing.

2. The electrochemical corrosion potential sensor according to claim 1, wherein the sensor unit includes a tube-shaped insulator joining between the corrosion potential detecting electrode and the metal casing;
wherein the lead wire passes through the insulator and metal casing; and
wherein the quasi-reference electrode is connected to the lead wire in the metal casing.

3. The electrochemical corrosion potential sensor according to claim 2, wherein the corrosion potential detecting electrode is a Pt electrode.

4. The electrochemical corrosion potential sensor according to claim 1, wherein the sensor unit includes an insulator in which a sealed region is formed attached to the metal casing;
wherein the corrosion potential detecting electrode is disposed in the sealed space; and
wherein the lead wire is disposed in the insulator and the metal casing, and made of the less noble metal in order to use as the quasi-reference electrode.

5. The electrochemical corrosion potential sensor according to claim 4, wherein the potential detecting electrode is a silver-silver chloride electrode.

6. The electrochemical corrosion potential sensor according to claim 1, wherein the sensor unit includes an insulator in which a sealed region is formed attached to the metal casing;
wherein the lead wire is disposed in the insulator and the metal casing; and
wherein the quasi-reference electrode is installed in the metal casing.

7. The electrochemical corrosion potential sensor according to claim 6, wherein the insulator is made of a zirconia membrane;
wherein platinum black powder is filled in the sealed region; and
wherein the electrochemical corrosion potential detecting electrode is the lead wire made of Pt lead wire and inserted into the platinum black powder.

8. The electrochemical corrosion potential sensor according to claim 1, wherein the less noble metal is a less noble metal generating an equilibrium potential less noble than an equilibrium potential of at least one of an oxidation reaction of H2/H+ and a redox reaction of H₂/H₂O and less noble than the corrosion potential detecting electrode, the lead wire and the metal casing.

9. The electrochemical corrosion potential sensor according to claim 1, wherein the less noble metal includes at least one of zirconium, zinc, aluminum, tin, manganese, tantalum, and iron.

10. The electrochemical corrosion potential sensor according to claim 2, wherein the less noble metal includes at least one of zirconium, zinc, aluminum, tin, manganese, tantalum, and iron.

11. The electrochemical corrosion potential sensor according to claim 4, wherein the less noble metal includes at least one of zirconium, zinc, aluminum, tin, manganese, tantalum, and iron.

12. The electrochemical corrosion potential sensor according to claim 6, wherein the less noble metal includes at least one of zirconium, zinc, aluminum, tin, manganese, tantalum, and iron.

13. An electrochemical corrosion potential measuring apparatus comprising:
an electrochemical corrosion potential sensor; and a potentiometer; and
the electrochemical corrosion potential sensor comprising:
a sensor unit including a tube-shaped metal casing and a corrosion potential detecting electrode attached to the metal casing and electrically insulated from the metal casing;
a lead wire connected to the corrosion potential detecting electrode, passed through in the sensor unit and extended to an outside of the sensor unit; and
a quasi-reference electrode disposed in the metal casing of the sensor unit and made of a less noble metal electrically connected with either the corrosion potential detecting electrode or the metal casing, the less noble metal generating potential less noble than the corrosion potential detecting electrode, the lead wire and the metal casing;
wherein the potentiometer disposed outside the electrochemical corrosion potential sensor is connected to the lead wire.

14. The electrochemical corrosion potential measuring apparatus according to claim 13, wherein the sensor unit includes a tube-shaped insulator joining between the corrosion potential detecting electrode and the metal casing;
wherein the lead wire passes through the insulator and metal casing; and
wherein the quasi-reference electrode is connected to the lead wire in the metal casing.

15. The electrochemical corrosion potential measuring apparatus according to claim 13, wherein the sensor unit includes an insulator in which a sealed region is formed attached to the metal casing;
wherein the corrosion potential detecting electrode is disposed in the sealed space; and
wherein the lead wire is disposed in the insulator and the metal casing, and made of the less noble metal in order to use as the quasi-reference electrode.

16. The electrochemical corrosion potential measuring apparatus according to claim 13, wherein the sensor unit includes an insulator in which a sealed region is formed attached to the metal casing;
wherein the lead wire is disposed in the insulator and the metal casing; and
wherein the quasi-reference electrode is installed in the metal casing.

17. The electrochemical corrosion potential measuring apparatus according to claim 13, wherein the less noble metal is a less noble metal generating an equilibrium potential less noble than an equilibrium potential of at least one of an oxidation reaction of H2/H+ and a redox reaction of H₂/H₂O and less noble than the corrosion potential detecting electrode, the lead wire and the metal casing.
